(19) United States
(12) Patent Application Publication
(10) Pub. No.: US 2011/0316705 A1
(43) Pub. Date: Dec. 29, 2011

(54) DEVICES, SYSTEMS, AND METHODS FOR MONITORING SLEEP POSITION

(76) Inventors: NICOLAAS deVRIES, Amsterdam (NL); RYAN P. BOUCHER, San Francisco, CA (US); ERIC N. DOELLING, Sunnyvale, CA (US)

(21) Appl. No.: 13/212,488

(22) Filed: Aug. 18, 2011

Related U.S. Application Data
(63) Continuation of application No. 12/982,537, filed on Dec. 30, 2010, now abandoned.
(60) Provisional application No. 61/335,067, filed on Dec. 31, 2009.

(51) Int. Cl. G08B 23/00

(52) U.S. Cl. 340/573.7

(57) ABSTRACT

Systems and methods provide a position sensing component that carries a gravity sensor sized and configured to provide a position dependent output indicative of the relative sleep position of the individual. The position sensing component can take the form of a strap sized and configured to be worn about the neck, or be integrated into a therapeutic oral appliance sized and configured to be worn within an oral cavity of the individual. The position sensing component is worn by the individual during sleep. The systems and methods compare the position dependent output with one or more benchmark conditions that correlate to a desired sleep position, and generate an alarm output when the individual is not in a desired sleep position, to thereby influence or alter the individual's sleep position to return the individual to a sleep position that correlates to a desired sleep position.

### RELATED APPLICATION

This application is a continuation of co-pending application Ser. No. 12/982,537 filed 30 Dec. 2010, which claims the benefit of U.S. Provisional Patent Application Ser. No. 61/335,067, filed Dec. 31, 2009, and entitled “Devices, Systems, and Methods for Monitoring, Analyzing, and/or Adjusting Sleep Conditions.”

### FIELD OF THE INVENTION

The invention generally relates to devices, systems, and methods for helping individuals experiencing sleep apnea, snoring, or other forms of sleep obstructive breathing achieve deep, restorative sleep.

### BACKGROUND OF THE INVENTION

Approximately fifty-six percent (5%) of sleep apnea sufferers are position dependent. Position dependent OSA has been defined when an individual experiences at least two times as many apneic events when sleeping in one of the four principal sleeping positions: left side, right side, prone (on the stomach), or supine (on the back). Snoring is often position dependent and is reduced when a patient changes its position.

### SUMMARY OF THE INVENTION

Systems and methods provide a position sensing component that carries a gravity sensor sized and configured to provide a position dependent output indicative of the relative sleep position of the individual. In one embodiment, the position sensing component comprises a strap sized and configured to be worn about the neck. In another embodiment, the position sensing component is integrated into a therapeutic oral appliance sized and configured to be worn within an oral cavity of the individual. The position sensing component is worn by the individual during sleep.

The systems and methods compare the position dependent output with one or more benchmark conditions that correlate to a desired sleep position. The systems and methods generate an alarm output comprising an audible sound and/or tactile vibration when the individual is not in a desired sleep position, to thereby influence or alter the individual's sleep position to return the individual to a sleep position that correlates to a desired sleep position.

In one embodiment, the systems and methods sense the duration of a particular position dependent output before generating an alarm output to prevent a false alarm.

### BRIEF DESCRIPTION OF THE DRAWINGS

FIG. 1 is a perspective view of a therapeutic system for monitoring sleep position, the system including first, second, and third components that serve complementary sensing, monitoring, and corrective functions, respectively.

FIGS. 2A and 2B are views of a gravity-sensitive position sensor that serves a sensing function in the system shown in FIG. 1, being sized and configured to be worn on the neck of an individual during sleep.

FIGS. 3A and 3B are views of gravity-position sensor that serves a sensing function in the system shown in FIG. 1, being integrated into a therapeutic oral appliance, which is worn in the oral cavity of an individual during sleep for the treatment for obstructive sleep apnea.

FIG. 4 is a diagrammatic view of the complementary sensing, monitoring, and corrective functions performed by the system shown in FIG. 1, including set, pre-programmed rules that establish a desired sleep position conducive to deep, restorative sleep.

### DESCRIPTION OF THE PREFERRED EMBODIMENTS

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

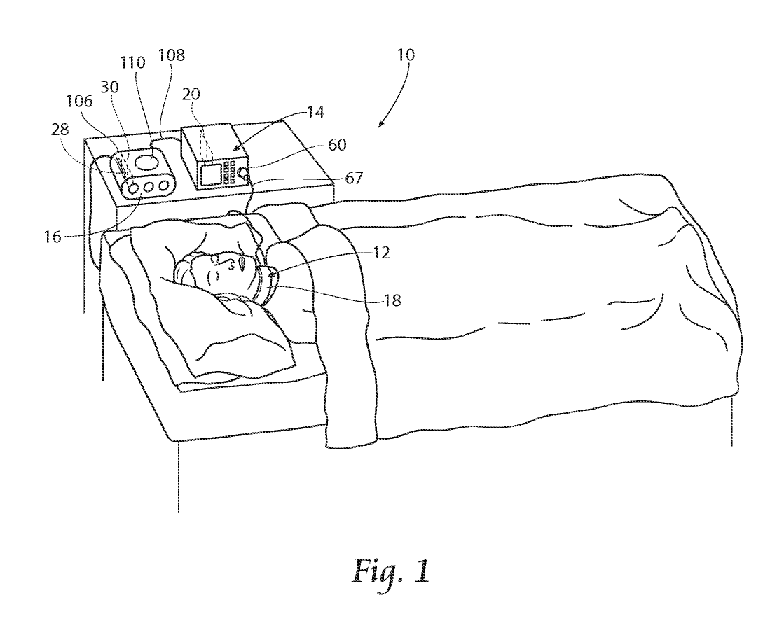

FIG. 1 depicts a representative therapeutic system 10 which is sleep position sensitive. The system includes the first, second, and third components 12, 14, and 16. Functionally, the three components 12, 14, and 16 desirably serve to teach or prompt the individual to assume a desired sleeping position, which is defined as the sleep position or positions most conducive to deep, restorative sleep for the individual.

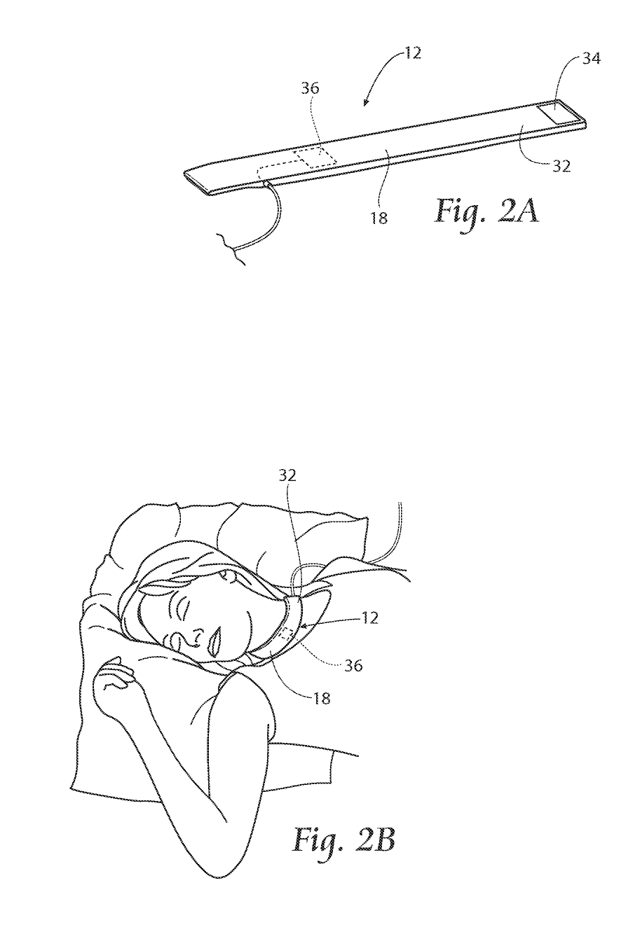

The first component 12 serves a position sensing function. In the embodiment shown in FIGS. 1, 2A, and 2B, the first component 12 includes a strap 32 that is sized and configured to be worn about the neck, as FIG. 2B shows. The strap 32 includes suitable fasteners 34 to quickly secure the strap about the neck and release the strap 32 between periods of use. In the illustrated embodiment, the fasteners comprise VELCRO® Material, but other forms of quick-release fasteners can be used, e.g., snaps, buttons, hooks, etc.

In this arrangement (see FIG. 2A), the first component 12 includes, as the sensing element 18, a gravity sensor 36 integrated into the strap 32. The gravity sensor 36 can be of conventional form. For example, it can take the form of a mechanical or electromechanical instrument based on “the bubble in a liquid” concept, like a Mercury gravity switch; or a gravity type potentiometer; or a capacitive gravity sensor; or other forms of miniaturized integrated circuit technologies, such as micro-switches; or forms of micro-electromechanical systems (MEMS).

When the strap 32 is worn about the neck (as FIGS. 1 and 2B show), the condition of the gravity sensor 36 reflects the relative inclination of the individual's torso. The gravity sensor 36 generates a position dependent output, which is calibrated to change depending upon which sleeping position the individual's torso assumes: left side, right side, prone (on the stomach), or supine (on the back).

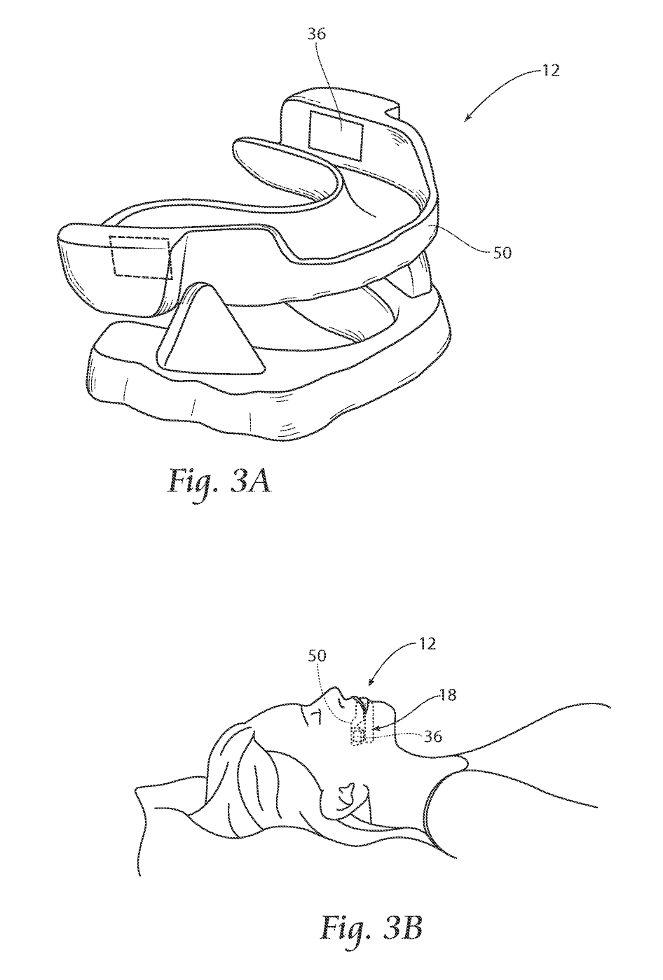

In the alternative embodiment shown in FIGS. 3A and 3B, the first component 12 is incorporated into a conventional therapeutic oral appliance 50. The term “therapeutic oral appliance” means an oral appliance that fits over the upper and lower teeth and is sized and configured, to hold the tongue and/or push the lower jaw forward and serve as an alternative to CPAP therapy for the treatment of obstructive sleep apnea. The therapeutic oral appliance 50 is configured for temporary placement into and removal from the oral cavity (as FIG. 3B shows). Thus, the therapeutic oral appliance 50 may used only during sleep and removed upon awakening. Removal of the therapeutic oral appliance 50 during waking hours prevents any interference with swallowing, speech, or other routine activities.

In this arrangement, the first component 12 includes, as the sensing element 18, a gravity sensor 36 integrated into the therapeutic oral appliance 50. As before described, the gravity sensor 36 can be of conventional form. For example, it can take the form of a mechanical or electromechanical instrument based on “the bubble in a liquid” concept, like a Mercury gravity switch; or a gravity type potentiometer; or a capacitive gravity sensor; or other forms of miniaturized integrated circuit technologies, such as micro-switches; or forms of micro-electromechanical systems (MEMS).

When the therapeutic oral appliance 50 is worn in the oral cavity (as FIG. 3B shows), the position dependent output of the gravity sensor 36 is indicative of the relative position of the individual's head on the sleeping surface. The position dependent output indicates whether the individual is resting on the left side of the head, right side of the head, back of the head, or face-down.

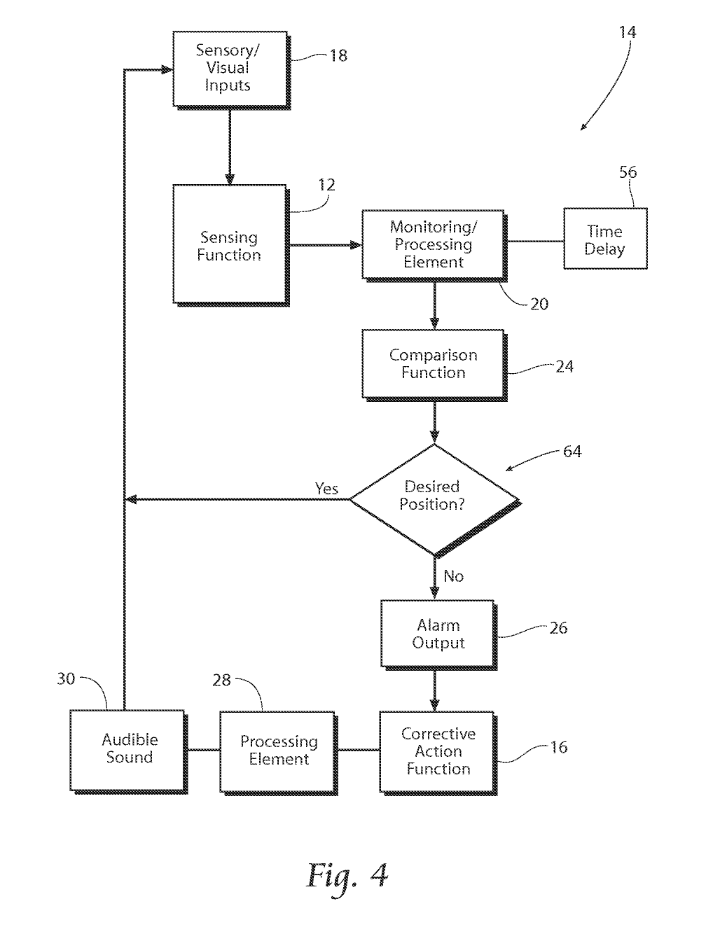

In the illustrated embodiment (see FIGS. 1 and 4), the second component 14 serves a monitoring function. The second component 14 receives the position-indicative output of the first component 12. As FIGS. 1 and 4 show, the second component 14 includes a processing element 20 that continuously or periodically registers the position-indicative output. As shown in FIG. 4, the processing element 20 includes a comparison function 24, which compares the registered position-indicative output with one or more benchmark or threshold conditions that correlate to a desired sleep position. When a correlation is lacking (meaning that the individual is not in the desired sleep position), the processing element generates an alarm output.

Desirably (as FIG. 4 diagrammatically shows), the processing element 20 includes a time-delay function 56 that senses the duration of a particular position-indicative output before registering it. In this way, transient changes of position are not registered and processed by comparison function 24. False alarms are thereby eliminated or reduced. The duration of the time delay can be incorporated into the pre-programmed rules and, desirably, be adjusted based upon false alarms experienced.

The form and fit of the second component 14 can vary. For example, as seen in FIG. 1, the second component 14 can be incorporated into a compact housing sized and configured to be placed bed-side. The housing 60 desirably houses the processing element 20, which can comprise a microprocessor implemented on an integrated circuit board.

Communication between the first and second components can be accomplished by linking the two components with a transmission cable 67 (shown in solid lines in FIG. 1). Alternatively, a wireless communication channel can be established between the two components, e.g., using an infrared transceiver.

The second component 14 can be battery powered, either by use of a standard industry-standard primary battery or an industry-standard rechargeable battery.

In one embodiment (as diagrammatically shown in FIG. 4), the processing element 20 of the second component 14 can include set, pre-programmed rules 64 that establish one or more sleep positions as the desired sleep position. The desired sleep position or positions can be ascertained by diagnosis of individual data or by analysis statistical patient population samples, or both.

For example, a left side and right side sleep position can be pre-programmed in the processing element as being desired. These sleep positions thereby become the benchmark conditions.

By continuously or periodically registering the position-indicative output of the first component 12, and by comparing the position-indicative output to the benchmark conditions or rules 64, the processing element 20 of the second component 14 either ascertains a correlation exists (i.e., the individual is resting in a desired sleep position) or ascertains that a correlation is lacking (i.e., the individual is resting on their back or front). As FIG. 4 shows, when a correlation is lacking, the processing element generates the alarm output 26. The alarm output 26 is transmitted to the third component 16 for inducing a change in the sleeping position.

The third component 16 is coupled to the second component. The third component 16 includes a processing element 28 that responds to the respective alarm output (based upon sleep position) and generates a corrective output.

The third component 16 also includes a corrective action element 30 that responds to the alarm output to influence or alter the individual's sleep position, to a return the individual to a sleep position that correlates to the desired benchmark conditions. Return to the benchmark conditions results in the return to deep, restorative sleep. Return to the desired benchmark conditions interrupts the alarm input.

As shown in FIG. 1, in any one of the systems described, the third component 16 can comprise a housing 106 sized and configured to be placed bed-side separate from the second component 14. The housing 106 desirably houses the processing element 28 of the third component 16, which can comprise a microprocessor implemented on an integrated circuit board. Communication between the second and third components 14 and 16 can be accomplished by linking the two components with a transmission cable 108 (shown in FIG. 1). Alternatively, a wireless communication channel can be established between the two components, e.g., using an infrared transceiver. Alternatively, the second and third component 16 can be incorporated or fully integrated incorporated into a single housing. The first, second, and third components 12, 14, and 16 can all be integrated into the therapeutic oral appliance 50 itself, to provide a fully self-contained system 10.

As shown in FIG. 1, the corrective action element 30 is coupled to a speaker 110 through which an audible sound is generated to awake the individual. The individual, now aroused, is forced to change his sleeping position to silence the sound.

Alternatively, or in combination, the corrective action element 30 can comprise an electrical buzzer or vibrator carried on the therapeutic oral appliance 50. The buzzer provides a tactile vibration sensation to awake the individual. The individual, now aroused, is forced to change his sleeping position to silence the vibration.

Alternatively, or in combination, the correct action element may adjust the therapeutic oral appliance 50 to extend the jaw forward to generate a larger airway.

Operation of the corrective action element 30 disturbs the individual in an auditory way sufficient to arouse the individual, thereby teaching the individual to alter their sleep position or posture and thereby return to a sleep state more conducive to deep, restorative sleep.

The above-described embodiments of this invention are merely descriptive of its principles and are not to be limited. The scope of this invention instead shall be determined from the scope of the following claims, including their equivalents.

We claim:

1. A system comprising
a position sensing component comprising a strap sized and configured to be worn about the neck and a gravity sensor carried by the strap sized and configured to provide a position dependent output indicative of the relative sleep position of the individual,
a monitoring component communicating with the gravity sensor to receive the position dependent output, the monitoring component including a processing element that compares the position dependent output with one or more benchmark conditions that correlate to a desired sleep position, the processing element generating an alarm output when the individual is not in a desired sleep position, and
a corrective action component communicating with the monitoring component including a corrective action element that, in response to the alarm output, generates an audible sound and/or tactile vibration to influence or alter the individual's sleep position to return the individual to a sleep position that correlates to a desired sleep position.

2. A system according to claim 1
wherein the strap includes fasteners to secure the strap about the neck and release the strap between periods of use.

3. A system according to claim 1
wherein the gravity sensor comprises a mechanical or electromechanical a bubble in a liquid switch; or a gravity type potentiometer; or a capacitive gravity sensor; or a miniaturized integrated circuit; or a micro-electromechanical device.

4. A system according to claim 1
wherein the processing element of the monitoring component includes a time-delay function that senses the duration of a particular position dependent output before generating an alarm output to prevent a false alarm.

5. A system comprising
a position sensing component comprising a therapeutic oral appliance sized and configured to be worn in an oral cavity of an individual and a gravity sensor carried by the therapeutic oral appliance sized and configured to provide a position dependent output indicative of the relative sleep position of the individual,
a monitoring component communicating with the gravity sensor to receive the position dependent output, the monitoring component including a processing element that compares the position dependent output with one or more benchmark conditions that correlate to a desired sleep position, the processing element generating an alarm output when the individual is not in a desired sleep position, and
a corrective action component communicating with the monitoring component including a corrective action element that, in response to the alarm output, generates an audible sound and/or tactile vibration to influence or alter the individual's sleep position to return the individual to a sleep position that correlates to a desired sleep position.

6. A system according to claim 5
wherein the gravity sensor comprises a mechanical or electromechanical a bubble in a liquid switch; or a gravity type potentiometer; or a capacitive gravity sensor; or a miniaturized integrated circuit; or a micro-electromechanical device.

7. A system according to claim 5
wherein the processing element of the monitoring component includes a time-delay function that senses the duration of a particular position dependent output before generating an alarm output to prevent a false alarm.

8. A method comprising
providing a position sensing component comprising a strap sized and configured to be worn about the neck and a gravity sensor carried by the strap sized and configured to provide a position dependent output indicative of the relative sleep position of the individual,
instructing the individual to wear the position sensing component about the neck while asleep,
comparing the position dependent output with one or more benchmark conditions that correlate to a desired sleep position, and
generating an alarm output when the individual is not in a desired sleep position.

9. A method according to claim 8
further including generating an audible sound and/or tactile vibration in response to the alarm output to influence or alter the individual's sleep position to return the individual to a sleep position that correlates to a desired sleep position.

10. A method according to claim 8
further including sensing the duration of a particular position dependent output before generating an alarm output to prevent a false alarm.

11. A method comprising
providing a position sensing component comprising an oral appliance sized and configured to be worn in an oral cavity of an individual and a gravity sensor carried by the oral appliance sized and configured to provide a position dependent output indicative of the relative sleep position of the individual,
instructing the individual to wear the position sensing component within the oral cavity while asleep,
comparing the position dependent output with one or more benchmark conditions that correlate to a desired sleep position, and
generating an alarm output when the individual is not in a desired sleep position.

12. A method according to claim 11
further including generating an audible sound and/or tactile vibration in response to the alarm output to influence or alter the individual's sleep position to return the individual to a sleep position that correlates to a desired sleep position.

13. A method according to claim 11
further including sensing the duration of a particular position dependent output before generating an alarm output to prevent a false alarm.
